(19) United States
(12) Patent Application Publication
(10) Pub. No.: US 2023/0200320 A1
(43) Pub. Date: Jun. 29, 2023

(54) STORAGE, GROWING SYSTEMS AND METHODS

(71) Applicant: OCADO INNOVATION LIMITED, Hatfield, Hertfordshire (GB)

(72) Inventor: Lars Sverker Ture LINDBO, Hatfield (GB)

(73) Assignee: OCADO INNOVATION LIMITED, Hatfield, Hertfordshire (GB)

(21) Appl. No.: 17/999,490

(22) PCT Filed: May 21, 2021
(86) PCT No.: PCT/EP2021/063655

§ 371 Date: Nov. 21, 2022

(30) Foreign Application Priority Data
May 22, 2020 (GB) 2007654.3

(51) Int. Cl. A01G 31/06; A01G 9/02; A01G 9/04; A01G 9/029

(52) U.S. Cl. CPC A01G 31/06; A01G 9/023; A01G 9/045; A01G 9/029

(57) ABSTRACT

A storing, germinating, propagating and or growing system for living organisms includes: at least one growth medium for germinating, propagating and or growing living organisms; at least one growth tray for receiving the at least one growth medium; and at least one rack for receiving one or more growth trays, wherein the one or more growth trays include an adaptable growth tray. An adaptable growth tray can include an extendable surface for positioning living organisms; and at least one mechanism for moving the tray between a compact configuration and an expanded configuration, wherein the surface for placing living organisms extends and contracts with the at least one mechanism moving between compact configuration and expanded configuration respectively.

### FIELD OF THE INVENTION

The present invention relates to storage systems. More specifically but not exclusively the present invention relates to storage systems for growing living organisms.

BACKGROUND AND RELATED ART

Conventional systems and methods for growing certain crops are well known. Most require large areas of land and need to be positioned in appropriate locations for the conditions required for the crops to be grown.

Indoor farming under artificial lights is gaining popularity for a large number of crops. Presently, mainly short plants, such as herbs and leafy greens are grown indoor under artificial light. More recently, advanced farming techniques such as hydroponics, aeroponics and other such cultivation systems have led to the ability to grow high quality crops indoors with very high utilisation of lighting, water and fertiliser. These systems have however been less efficient in terms of land use, capital and labour.

The present disclosure describes systems and methods for improving the efficiency of these types of techniques.

Some commercial and industrial activities require systems that enable the storage and retrieval of a large number of different products. One known type of system for the storage and retrieval of items in multiple product lines involves arranging storage containers or containers in stacks on top of one another, the stacks being arranged in rows. The storage containers or containers are accessed from above, removing the need for aisles between the rows and allowing more containers to be stored in a given space.

Methods of handling containers stacked in rows have been well known for decades. In some such systems, for example as described in U.S. Pat. No. 2,701,065, to Bertel, the contents of which are incorporated herein by reference, comprise free-standing stacks of containers arranged in rows in order to reduce the storage volume associated with storing such containers but yet still providing access to a specific container if required. Access to a given container is made possible by providing relatively complicated hoisting mechanisms which can be used to stack and remove given containers from stacks. The cost of such systems are, however, impractical in many situations and they have mainly been commercialised for the storage and handling of large shipping containers.

The concept of using freestanding stacks of containers and providing a mechanism to retrieve and store specific containers has been developed further, for example as described in EP 0 767 113 B to Cimcorp, the contents of which are incorporated herein by reference. EP'113 discloses a mechanism for removing a plurality of stacked containers, using a robotic load handler in the form of a rectangular tube which is lowered around the stack of containers, and which is configured to be able to grip a container at any level in the stack. In this way, several containers can be lifted at once from a stack. The movable tube can be used to move several containers from the top of one stack to the top of another stack, or to move containers from a stack to an external location and vice versa. Such systems can be particularly useful where all of the containers in a single stack contain the same product (known as a single-product stack).

In the system described in EP'113, the height of the tube has to be as least as high as the height of the largest stack of containers, so that that the highest stack of containers can be extracted in a single operation. Accordingly, when used in an enclosed space such as a warehouse, the maximum height of the stacks is restricted by the need to accommodate the tube of the load handler.

EP 1037828 B1 (Autostore) the contents of which are incorporated herein by reference, describes a system in which stacks of containers are arranged within a frame structure. Robotic load handling devices can be controllably moved around the stack on a system of tracks on the upper most surface of the stack.

Other forms of robotic load handling device are further described in, for example, Norwegian patent number 317366, the contents of which are incorporated herein by reference.

A further development of load handling device is described in PCT publication WO 2015/019055 A1 (Ocado Innovation Limited), the contents of which are incorporated herein by reference, where each robotic load handler only covers one grid space, thus allowing higher density of load handlers and thus higher throughput of a given size system.

In such known storage systems a large number of containers are stacked densely. The containers are conventionally used to store goods to supply online grocery orders picked by robots.

Storage systems are known to be adapted and used for growing living organisms using hydroponic methods.

Hydroponics is a method of growing plants without soil by instead using mineral nutrient solutions in a water solvent. Plants typically grown in soil or land may be grown with their roots exposed to the nutritious liquid, or the roots may be physically supported by a medium such as perlite, Rockwool^{TM}, vermiculite, coco fibre, sand or gravel. The nutrients used in hydroponic systems can come from an array of different sources. The delivery frequency is governed by parameters such as plant size, plant growing stage, climate, substrate, and substrate conductivity, pH, and water content.

In connection with growing crops for consumptions, pyrrolizidine alkaloids (PAs) are a group of chemicals that can be naturally occurring in plants as a defence mechanism against insects, other pests or microbiological hazards. Some PAs exhibit hepatotoxicity that is damaging to the liver. Therefore PAs may be subject to regulation in food and particularly in herbs and medicines because a build-up of these chemicals in the body can represent a health risk. PAs can be particularly prevalent in crops such as medicinal herbs so there is a need to minimise the level of PAs found in crops. The level of PAs may be controlled as a result of controlling the growing environment.

In hydroponic growing systems the quantity of water required to grow a crop to harvest is greatly reduce compared with soil-based agriculture. In a run-to-waste system, sometimes referred to as “The Bengal System”, nutrient and water solution is periodically applied to the medium surface. Nutrient-rich waste may be collected and re-used in the system.

A development of a growing system and method is described in PCT publication WO2016/166311A1 “Growing Systems and Methods” (Ocado Innovation Limited), the contents of which are incorporated herein by reference, where plants are grown in containers and the containers are stored in stacks. Within individual containers, services are provided for enabling plants to grow. Load handing devices are used to take containers from the stack and deposit them in alternative locations.

UK application GB1911505.4 (Ocado Innovation Limited) “Hydroponics Growing System and Method”, the contents of which are incorporated herein by reference, discloses another hydroponic growing system. Seeds are pre-treated and germinated in a ‘high care’ portion to reduce contamination during germination. Seedlings are then moved to a growing room in support vehicles containing growing which trays move along a frame or rack as the crop grows and until the crop is ready for harvesting. The system disclosed includes illumination apparatus above each growing station, and a recirculating irrigation system for providing nutrients to a growing crop. The irrigation system uses mains water blended with nutrients, which is pumped to the growing crop. Water which drains from the racks is reintroduced to the water blend to minimise waste water.

Further developments are disclosed in UK applications GB1918018.1 and GB1918020.7 both titled “Storage, Growing Systems and Methods” (Ocado Innovation Limited), the contents of which are incorporated herein by reference.

The present invention aims to further develop the storage and growing systems and methods of growing living organisms and or crops. It follows that the present invention aims to maximise the yield, improve efficiency in terms of use of assets, resources and services required by the crop. For example but not limited to efficiencies may comprise: reduced needs for water; reduced needs for fertilisers and pesticides; increase in the control of taste; increase in the control texture and other features of the crop; efficiencies in the use of artificial lighting; efficiencies in maintenance of the facilities; improved utilisation of space, an increase in automation and corresponding decrease in labour.

Overall, the present invention aims to address issues enabling more growth in a smaller space with less electricity consumption, less capital expenditure, less maintenance and less labour cost.

Furthermore, the benefits from controlled environment and or vertical farming systems are likely to become more pronounced as improved infrastructure components such as more efficient and cheaper lights, and cheaper electricity become available.

This application claims priority from GB patent application number GB2007654.3 filed on 22 May 2020, the contents being herein incorporated by reference.

### SUMMARY OF THE INVENTION

Aspects of the invention are set out in the accompanying claims.

A storing, germinating, propagating and or growing system for living organisms is provided, comprising: at least one growth medium for germinating, propagating and or growing living organisms; at least one growth tray for receiving said at least one growth medium; and at least one rack for receiving one or more growth trays, wherein the one or more growth trays comprise an adaptable growth tray.

The system may further comprise a central control facility. For example, the central control facility may include a central computer receiving information from sensors throughout the system, and providing instructions to automated units that facilitate the automation and running on the system.

Thus, the system is adaptable to meet the needs of an improved hydroponic growing system.

The system provides a facility in which a method of hydroponic growing may be carried out.

Accordingly, a method of storing, germinating, propagating, and or growing a plurality of living organisms is provided, the method comprising the steps of: providing a living organisms with a controlled environment to encourage germination, propagation and or growth of the living organisms, wherein, as the living organism grows and requires more space, expanding the available growing space for the living organism to allow additional space in the horizontal plane (x-y plane).

The method may further comprise the steps of: in a seeding area, seeding at least one growth medium with seeds of a living organism; placing the growth medium(s) on one or more growth trays; transferring the tray(s) to portion comprising a germination volume and or a growing volume, comprising one or more racks; and or transferring the growth trays to a high care portion. The method may further comprise transferring the growth tray to a harvesting area, and harvesting the crop.

Each of the at least one growth medium, at least one growth trays and or at least one racks may be accessible and adapted to be transferred within the system to allow flexibility within the system to efficiently move items around the space and between difference zones, such as high care zones and low care zones, and to dispatch areas, or between different locations within each zone or portions of the system.

Seeds may be seeded onto the growth medium and germinated and grown on the growth medium until the crop is ready for harvesting. The growth medium is placed in growth trays. The growth trays provide a storage facility and or vehicle in which the living organisms may be moved around the system until they are harvested. In this way, seedlings and plants may remain undisturbed in situ as they grow to maturity and the system is adaptable, as described further hereinbelow, in order to facilitate and accommodate a germinating and growing a crop to harvest. Racks may be used to adaptably accommodate trays with plants of different sizes. Use of racks may provide efficiencies of use of floor space, and efficiencies in transport. Growth trays may be used adaptably to accommodate growing living organisms, in particular plants. Furthermore, the ability use trays and racks around the system allows for further control of environment during different phases of the life cycle of the organism and commercial cycle of the facility.

The system may further comprise services to enable propagation and or growth of the living organisms, such as, water, nutrients, fluid drainage lighting and maintaining air-flow around the crops within a facility or growing volume.

Thus, the system is adaptable to provide expansion in up to two spatial dimensions for a growing crop, as the crop increases in size for example. Thereby, advantageously, reducing the need for dividing, and transferring plants whilst they mature into a harvestable crop. Another reason living organisms may require more space around them is to increase airflow around the organism and to reduce the building up of moisture that could lead to mould or mildew, for example.

Further, the adaptability of the system may enable more automation of the production process.

Determining when to expand the growth space may be determined by a control system using a number of systems, or an operator may carry out a visual inspection.

An adaptable growth tray for germinating, propagating and or growing living organisms, is provided. The adaptable growth tray comprises: an extendable surface for positioning living organisms; and at least one mechanism for moving the tray between a compact configuration and an expanded configuration, wherein the surface for placing living organisms extends and contracts with the at least one mechanism moving between compact configuration and expanded configuration respectively.

For the purposes of describing the invention, the terms “extendable” and “expandable” may be used interchangeably. The terms “compressed”, “contracted”, “compact”, “closed” may be used interchangeably to describe the compact configuration or state of the adaptable growth tray or components thereof, and the terms “extended”, “expanded”, “open” may be used interchangeably to describe the expanded configuration or state of the adaptable growth tray or components thereof.

A growth medium may be placed into the growth tray and used for seeding, germination and growing a crop to maturity. As a crop grows it is typical that the seedlings will need to be divided, or thinned, and transferred to other growth mediums and larger trays as the seedlings become larger in order to maintain space around the juvenile plants in order to allow room for growth. It is intended that the growth tray may be used to expand the area for growth, i.e. in the lateral, x- y- or planar direction, as the crop requires more space between each individual plant. An adaptable tray thereby negates or reduces the need to thin and or transfer the crop during growth. Reducing the need for this reduces the number of processes required during the growing cycle thereby reducing the need for labour—be it manual or automated—and may also increase the yield of the crop by avoiding potential damage whilst it is growing. Further, the crop is less likely to become damaged during growth due to broken roots and stems during the process of increasing space around the plants. Further, the trays can occupy less shelf or rack space while the plants are small thereby making more efficient use of the space in the growing room.

An adaptable growth tray is provided, wherein the extendable surface may comprise a first portion and one or more second portions, wherein the second portions nest within the first portion and are movable relative to the first portion and relative to each other, and wherein when the growth tray is in the compact configuration the first and second portions are nested, and when the growth tray is in the expanded configuration the second portions expand to increase the surface for positioning living organisms.

The tray may be movable in a telescoping fashion.

Thus, in this arrangement, the tray can expand in one dimension along its length. In use, if rows of a crop were positioned along the tray, as the tray expands the rows will become more spaced out. However, the space between individual plants in a row will remain the same. In order to avoid breakages of the roots, due to them becoming intertwined between plants, individual plants may be placed in separate compartments. Alternatively, the trays could be expanded slowly as the plants grow so that the roots stretch with the movement, even if they are intertwined. Thus, it is advantageously possible to avoid breaking roots whilst providing the plants with more space for growth.

More than one second portion may be nested within the first portion to enable additional expansion area—the first portion and second portions, may be thought of similarly to leafs in an extendable table. In some arrangements, a single row of plants may be positioned on each leaf. In this way, all the rows will separate or have a greater distance between them as the tray expands. In other arrangements, two or more rows of plants may be positioned on each leaf. In this arrangements, the distance between rows is only increased where rows are on different leaves. Thus, in the case of two rows of plants per leaf, the distance is increased between every other row as the area of the tray is expanded.

An adaptable growth tray is provided, wherein the extendable surface may comprise an extendable assembly, comprising a plurality of pots for positioning living organisms and a plurality of connecting members interconnecting the plurality of pots, wherein when the growth tray is in the expanded configuration the plurality of connecting members extend to increase the distance between the plurality of pots.

The connecting members may be elastic members, or rigid hinged members, or a compliant mechanism.

An adaptable growth tray is provided, wherein the extendable surface may have a negative Poisson ration under tension and may comprise a kirigami structure. The extendable surface may comprise a bi-stable auxetic metamaterial (BAM). An adaptable growth tray is provided, wherein the extendable surface may be extendable in two dimensions simultaneously.

Thus, in this arrangement, the tray surface may be expanded in two dimensions at the same time, i.e. in both the x-direction and the y-direction in the x-y plane.

The extendable surface may be limited to spaced apart portions or clusters of extendable structure. In this way, the tray may maintain its overall dimension to conform with the available space on a racking system, while the extendable surface increases in area within the overall dimension.

An adaptable growth tray may be provided, wherein the at least one mechanism is a scissor mechanism arranged along at least one edge of the extendable surface. Other mechanisms may be used, for example, a compliant mechanism.

The scissor mechanism may be arranged along each edge that extends, i.e. along opposed edges. Where the tray extends in one dimension a pair of mechanisms may act on the extending edge, on opposed edges. The mechanism may act and be controlled in unison or they may be arranged to act independently. The “stretching energy” may come from outside of the tray i.e. by pulling on the edges of the tray, or from “inside”, i.e. from an on-board motor pushing the edges of the tray apart.

An adaptable growth tray may be provided, wherein the at least one mechanism is a screw mechanism.

The screw mechanism may be arranged such that one or more lead screws extend towards one or more corners of the adaptable growth tray, and/or towards one or more edges of the adaptable growth tray. Where more than one lead screw is provided, the lead screws may act and be controlled in unison or they may be arranged to act independently.

An adaptable growth tray may be provided, wherein the at least one mechanism is a rack and pinion mechanism.

The rack and pinion mechanism may be arranged such that one or more racks extend towards one or more corners of the adaptable growth tray, and/or towards one or more edges of the adaptable growth tray. Where more than one rack is provided, the lead screws may act and be controlled in unison or they may be arranged to act independently.

For both the screw mechanism and the rack and pinion mechanism, the mechanism can be actuated by any suitable means, or example by an inbuilt motor, or by a screwdriver or Allen key operated by a human or by an AGV.

It will be understood that any suitable mechanism may be used to move the tray between compact and expanded configurations. Further, it will be understood that the mechanism may be operated manually or the transition process may be automated to move between configurations. For example, a motor may be used to slowly and continually expand the growing area at a rate to enable the plants to adapt with the expansion. Thus, the adaptable growth tray may be used to stretch and increase the size of the elastic cover, and increase the area for the crop.

An adaptable growth tray may further comprise an elastic cover having an array of holes arranged in rows, AND OR a cover having an array of holes arranged in groups, wherein the arrangement of the array of holes is substantially complimentary to the extendable surface. An adaptable growth tray wherein each of the holes in the array of holes may be supported by a substantially rigid eyelet.

In some arrangements, the growth tray may comprise an elastic sheet having an array of holes, though which plants may grow. The holes may provide controlled plant placement, in order to optimise spacing on the mat. The holes may also provide assistance to drainage of the growth trays. Further, the elastic sheet may act as a barrier between the roots and the stem of a plant. Depending on the material chosen, the sheet may prevent light from falling on the roots—which is important to many plants.

In some arrangements there may be additional growth medium layered with the growth mat. In some embodiments, the growth mat is placed in layered configuration with the adaptable growth tray and the sheet or cover. It will be appreciated that a porous substrate such as cork or peat may be used in place of a growth mat.

In some arrangements, expansion of the growth tray is motorized.

An adaptable growth tray may be provided, further comprising an extendable frame surrounding the extendable surface, at least one side of the extendable frame comprising a first portion and one or more second portions, wherein the second portions nest within the first portion and are movable relative to the first portion and relative to each other, and wherein when the growth tray is in the compact configuration the first and second portions are nested, and when the growth tray is in the expanded configuration the second portions are expanded to increase the surface for positioning living organisms.

The extendable frame may be movable in a telescoping fashion. More than one second portion may be nested within the first portion to enable additional expansion length. Two opposite sides of the extendable frame may be extendable, such that the extendable frame can be extended in one dimension. Alternatively, all four sides of the extendable frame may be extendable, such that the extendable frame can be extended in two dimensions simultaneously.

An adaptable growth tray may be provided, further comprising an elastic frame surrounding the extendable surface.

In this way, the present invention addresses some of the problems of the prior art and provides a method and system of increasing the efficiency or yield of a hydroponic growing system.

### BRIEF DESCRIPTION OF THE DRAWINGS

The invention will now be described with reference to the accompanying diagrammatic drawings in which:

FIG. 1 is a schematic diagram showing a hydroponic growing system;

FIGS. 2a-2c show an extendable growth tray, FIG. 2a is in its compressed state, FIG. 2b is in its fully extended state and FIG. 2c is in an intermediate state;

FIGS. 3a-3c show an extendable growth tray with the cover and the eyelets, FIG. 3a is in its compressed state, 3b is in its fully extended state and 3c is in an intermediate state;

FIGS. 4a-4c show the extendable growth tray of FIGS. 3a-3c where plants are growing in the tray, FIG. 4a is in its compressed state with small plants, FIG. 4b in its fully extended state with fully grown plants and FIG. 4c in an intermediate state;

FIGS. 5a-5c show a diagrammatic illustration of how mechanisms with negative Poisson ratios can be implemented in a growth tray, FIG. 5a shows a single unit in a compressed state, FIG. 5b shows six units in a tessellating arrangement and FIG. 5c shows the tessellating arrangement in its extended state;

FIGS. 6a and 6b show illustrates an array of mechanisms with a negative Poisson ratio of FIGS. 5a-5c, FIG. 6a shows the array its compressed state, and FIG. 6b shows the arrangement in extended or expanded state;

FIGS. 7a and 7b show a plane view of an extendable growth tray with clusters of expandable portions having negative Poisson ratio, using a number of mechanisms similar to the mechanism of FIGS. 5a-5c, 6a and 6b, FIG. 7a is in its compressed state where tray has a single width, and FIG. 7b in an extended state where the tray has a double width and the clusters are expanded cross the width and along the length of the tray;

FIGS. 8a-8c show a perspective view of the extendable growth tray of FIG. 7 with an expandable elastic sheet in the tray, FIG. 8a is in its compressed state with small plants, FIG. 8b is in an extended state with fully grown plants, and FIG. 8c is in an intermediate state; and

FIGS. 9a-9c show the extendable growth tray of FIGS. 7a and 7b where plants are growing in the tray, FIG. 9a is in its compressed state with small plants, FIG. 9b is in an extended state with fully grown plants, and FIG. 9c is in an intermediate state.

FIG. 10 shows a perspective view of an extendable growth tray in (a) compressed, and (b) extended states.

FIG. 11 shows a perspective view of (a) a screw mechanism, and an extendable growth tray with the screw mechanism in (b) compressed, and (c) extended states.

FIG. 12 shows a plane view of an extendable growth tray with the screw mechanism of FIG. 11, in (a) compressed, and (b) extended states.

FIG. 13 shows a plane view of a rack and pinion mechanism in (a) compressed, and (b) extended states.

FIG. 14 shows (a) an extendable growth tray with the rack and pinion mechanism of FIG. 13 and (b) the rack and pinion mechanism with a ratchet mechanism.

FIG. 15 shows a perspective view of an extendable growth tray with an extendable frame in (a) compressed, and (b) (c) extended states.

FIG. 16 shows a perspective view of an extendable assembly in (a) compressed, and (b) extended states.

FIG. 17 shows a plane view of the extendable assembly of FIG. 16 in (a) compressed, and (b) extended states.

FIG. 18 shows a perspective view of the extendable assembly of FIG. 16: (a) in compressed state with small plants, (b) in compressed state with plants of intermediate size (c) in extended state with plants of intermediate size and (d) in extended state with plants of large size.

FIG. 19 shows a perspective view of the extendable assembly of FIG. 16: (a) in compressed state with small plants, (b) in compressed state with plants of intermediate size (c) in extended state with plants of intermediate size and (d) in extended state with plants of large size.

FIG. 20 shows a perspective view of an extendable tray with extendable assembly and extendable frame: (a) in compressed state with small plants, (b) in compressed state with plants of intermediate size (c) in extended state with plants of intermediate size and (d) in extended state with plants of large size.

FIG. 21 shows a perspective view of an extendable frame with extendable cover in (a) compressed, and (b) extended states.

### DETAILED DESCRIPTION

The present invention forms a part of a larger hydroponic growing system. It will be appreciated that the larger system described herein is exemplary only, and other combinations and configurations of the apparatus and equipment described are anticipated by the inventors of the present disclosure without departing from the scope of the invention described herein.

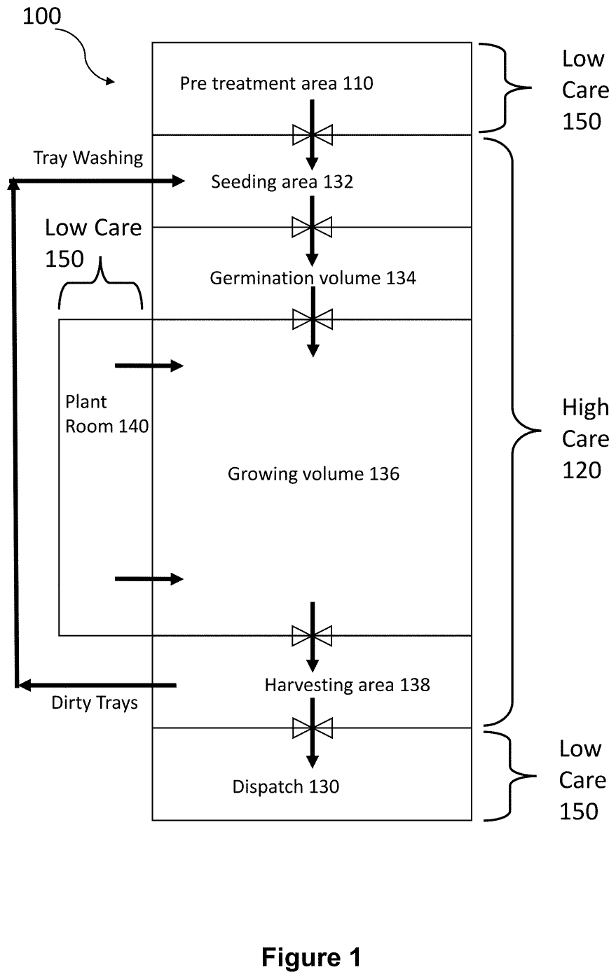

Referring to FIG. 1, a larger hydroponic growing system 100 comprises a system in which crucial parts of the system 100 comprise a ‘high-care’ environment. A high-care environment is defined as an area requiring high levels of hygiene, careful and clean working practices, fabrication, and the design of facilities and equipment to minimise product contamination with regard to microbiological hazards. Generally speaking products produced in high-care areas will have undergone a process to reduce any microbiological contamination prior to entering the high-care area.

In hydroponic growing systems, contamination in the absence of such a high-care environment can lead to reduction in yield of a given crop, infestation requiring sanitisation of a significant volume of the growing chamber or loss of a given crop entirely. Further, crops may have a higher level of PAs.

As illustrated in the schematic diagram of FIG. 1, the hydroponic growing system 100 may comprise a seed and equipment pre-treatment area 110, a high-care portion 120 and a dispatch portion 130.

The seed and equipment pre-treatment area 110 may comprise hot water treatment means, UVC treatment means and in the case of the seeds, may comprise agitation means. The high-care portion 120 may comprise a seeding area 132, a germination volume 134, a growing volume 136, and a harvesting area 138.

The high-care portion 120 of the hydroponic growing system 100 may comprise equipment designed, treated and installed so as to assist in the maintenance of a high-care environment for seeding, germinating, growing and harvesting crops of any variety.

In order to assist with cleaning equipment located within the high-care portion 120, the equipment is preferably raised off the floor enabling easier and more effective cleaning of the equipment and floor. Further, all uprights of apparatus and where possible as much of the equipment in the high-care portion 120 of the system 100 as possible is painted or treated with antimicrobial paint such as, for example, paint comprising silver. For instance, the walls, floor and ceiling of the high-care portion 120 of the hydroponic growing system 100 are painted white to enable visual checks of the overall cleanliness of the growing system 100.

To assist with preventing contamination by water borne contaminants, preferably the amount and length of drainage system is reduced. Further this may assist with enabling regular deep cleaning of the whole system 100.

It will be appreciated that ethylene may be produced in the germination and growing volumes 134, 136 of the system 100 and this ethylene can stimulate decomposition in fresh or growing produce. Thus, it is vital that where unprocessed produce is held in storage, ethylene is controlled, to ensure that the freshness is preserved and that waste from the process is minimised. Preferably, the high-care portion 120 of the hydroponic growing system 100 may comprise means for removing ethylene. For example, such ethylene removal means may comprise ethylene scrubbers that comprise dry chemical scrubbers. These machines generally have a pre-filter, a chemisorption bed and an after filter acting so as to remove ethylene from the environment. However, it will be appreciated that any other form of ethylene removal means may be used.

Further, it is important to maintain air-flow around the living organisms. For example, if the roots of a plant are properly oxygenated then the growing capabilities of the plant may be improved. It also helps to maintain a more stable or constant humidity around the root structure and plant thereby reducing the incidence of fungal or bacterial growth which may become prevalent where humidity is not controlled. Further, in low air-circulation conditions, leaves may be effected by mildew.

In use, a hydroponic growing system 100 comprising a high-care portion 120 may be used to produce crops with little contamination. Seeds for planting and growing in a high-care environment are pre-treated in such a seed pre-treatment area 110. Such pre-treatment may comprise hot water, and optionally UVC treatment. Additionally, the seeds may be agitated. Once treated, the seeds are bagged and sealed. The pre-treatment area 110 may be a substantially sterile environment.

Further, in the pre-treatment area 110, all growing media is treated with UVC, and equipment for use in the high-care facility is treated with UVC to reduce as far as possible the chances of contamination within the high-care portion 120 of the hydroponic growing system 100. Seeds are also treated with hot water.

A plant room 140 provides plant services to each zone, portion and volume of the hydroponic growing facility. In some instances, it will be appreciated that duplicate service systems are used to separately serve low care and high-care portions 150, 120 to avoid contamination of high-care portions 120 from low care portions 150. Plant services may comprise, control boxes, air handling devices to maintain air humidity and temperature, air compression systems, water treatment and pump facilities, and UVC treatment machines, for example and amongst other things.

Once the seeds, the growing media and trays have been pre-treated they are transferred to the high-care portion 120 of the hydroponic growing system 100.

These pre-treatment steps may be undertaken at a location remote from the high-care portion 120 of the system 100, however, it will be appreciated that such pre-treatment zones may be co-located with the high-care portion 120 of the hydroponic growing system 100.

The high-care portion 120 of the hydroponic growing system 100 comprises a seeding area 132, a germination volume 134, a growing volume 136, and a harvesting area 138.

As required, the cleaned seeds are further treated by, for example, UVC radiation immediately prior to arrangement on growing medium in the seeding area 132, the growing medium being located in the trays. The seeds may be continually vibrated by vibrating means comprising, for example, a vibrating plate whilst UVC treated and whist being arranged on the growing medium. The speed of vibration of the plate may be controllable and the speed used will depend on the particular seeds being processed, the size and variety of the seed and the effect of the vibration with the UVC on the seeds.

Once the equipment and seeds have been pre-treated as required, the seeds are arranged on the growing medium within the trays, and the trays may pass through a transfer hatch located between the seeding area 132 and the germination volume 134. The transfer hatch may comprise means for transferring trays between areas and volumes of the system 100 bounded by walls, for example, in a manner consistent with the maintenance of the high-care environment. It will be understood that a number of transfer hatches may be present in the system 100.

The germination volume 134 may comprise racking on which the trays comprising the seeds are placed for a predetermined time. The predetermined time depends on the seed type, the growth cycle and the yield required for any given crop. It will be appreciated that control of the environment in the germination volume 134 may enable the time taken to germinate seeds to be controlled to a certain extent.

The environment in the germination volume 134 may be controlled. For example, the temperature, humidity, air flow and lighting conditions may be controlled either manually or by a suitable control mechanism. The environment in the germination volume 134 may be sensed by a series of sensors and detectors and the environment controlled according to the environment detected by the sensors or detectors. Such control may be carried out remotely by a suitable control utility.

Once germinated, the seeds are moved to the growing volume 136. For example, the growing trays may be placed on moveable racking or may be placed using a pick and place system either robotically or manually. Similarly to the environment of the germination volume 134, the environment of the growing volume 136 may be controlled. The environment in the growing volume 136 may be sensed by a series of sensors and detectors and the environment controlled according to the environment detected by the sensors or detectors. Such control may be carried out remotely by a suitable control utility.

The germinated seeds remain in the growing volume 136 until the crop is deemed ready to harvest. This may be determined visually by operators or may be determined remotely using camera means to view the progress of growth of the crop.

Many crops may be transplanted after they have had 5-7 days of growing. Once transplanted the plants may remain in situ until harvesting.

Once deemed ready to harvest, the trays comprising the crops are removed from the growing volume 136 and transferred by any suitable means, robotic or manual, to a harvesting area 138 where the crop is picked, harvested or processed in the appropriate manner for the given crop. Once harvested, the crop may be bagged for onward delivery to direct customers or to commercial retail enterprises.

The dirty trays may be removed from the high-care portion 120 for washing and deep clean before returning to the seeding area 132 to be reseeded with a new crop.

Only once the crop is harvested and bagged will it leave the high-care portion 120 of the hydroponic growing system 100 to the dispatch portion 130.

It will be appreciated that high-care seeding, germinating, harvesting and growing environments reduce contamination during the production of crops in a hydroponic growing system 100.

It will be appreciated that the seeding area 132, the germination volume 134, the growing volume 136 and the harvesting area 138 may be collocated in a single building. However, it will also be appreciated that it is possible to locate the areas and volumes in different locations, however, the high-care environments would need to be controlled in a similar manner across all locations with high-care transfer means implemented between locations.

It will further be appreciated that the seeding area 132, the germination volume, the growing volume and the harvesting area 138 may be located in adjacent rooms of a single building or may be located in a single volume with separately definable volumes as required. In this case, barriers and air locks between the various areas and volumes will be used.

It will be appreciated that the system 100 described above includes many known aspects of high-care treatment. However, it may become possible to apply other treatment regimens or to use other forms of equipment to achieve the result described herein.

Moreover, the system 100 described above may be used to grow a single crop or multiple crops in a single facility. Any crop suitable for growth in a hydroponic growing system 100 may be grown in a high-care portion 120 of such a growing system 100.

Further it will be appreciate that a nutrient rich fluid, provided to the may be recycled for reuse. However, the fluid will require filtering and rebalancing to ensure that it is suitable for re-use. Captured drain fluid, through a drainage system is filtered to remove any larger particles, and passed through UV systems to maintain a given level of cleanliness to the fluid. The cleaned fluid is then dosed to optimum levels of nutrients which is required to be reused by the crop(s).

As mentioned above, growth trays may be placed on a rack. Alternatively growth trays may be placed in another form of stacking system, for example, on a frame or rack as previously disclosed in UK application GB1911505.4 “Hydroponics Growing System and Method” hereby incorporated by reference. Alternatively, trays may be attached to a “smart pole” as disclosed patent application no. GB1948018.1 filed on 9 Dec. 2019 titled STORAGE, GROWING SYSTEMS AND METHODS (Ocado Innovation Limited), hereby incorporated by reference.

When seeded growth trays or growth trays containing seedlings are placed on a rack lighting and other services or utilities as controlled by a central control means, for example, provision of a fluid nutrient mix, and environmental control for air flow, humidity, temperature and circulation to encourage propagation and or growth of the plants whilst on the rack. As the crop grows, the trays may be rearranged on the rack or the rack may be adapted in order to provide sufficient space for growing in order to provide sufficient space and optimised growing conditions for the living organism to grow as it progresses from germination to a mature organism, ready for harvesting.

When the living organisms have grown to maturity the growth tray(s) are transferred to a harvesting area 138, and harvesting the crop. The growth trays may be transferred manually from the stack. Alternatively, a robotic or automated device such as a robotic load handling device suitable for operating with stacked storage systems may be employed to transfer the tray(s).

The growth rack 210 may comprise two or more platforms 212. The lower or underside of each of the platforms 212 above the base or lowermost platform are provided with lighting 222. The lighting 222 is provided to illuminate the platform 212 adjacent-below in the stack, and for example, in use, illuminates seeds or a growing crop. The lighting 222 may be controlled by a central control means (not illustrated) to optimise the conditions required for the crop.

Lighting is one of many service devices that may be integrated into the rack to encourage propagation and or growth of living organism(s) placed on the platforms. Other services provided include the provision of nutrient rich fluid and water, control of humidity via misting apparatus, air-flow control and temperature control, via integrated or semi-integrated systems and structures.

The platforms are suitable for supporting one or more growth trays. The growth tray(s) may be of the type disclosed in patent application no. GB1918020.7 filed on 9 Dec. 2019 titled STORAGE, GROWING SYSTEMS AND METHODS (Ocado Innovation Limited), the contents of which are incorporated herein by reference.

When seeded growth trays or growth trays containing seedlings are placed on the platform(s) 212 of a growth rack 210 as described herein, the lighting 222 is used, as controlled by a central control means, to encourage propagation and or growth of the plants whilst in position on the growth rack 210.

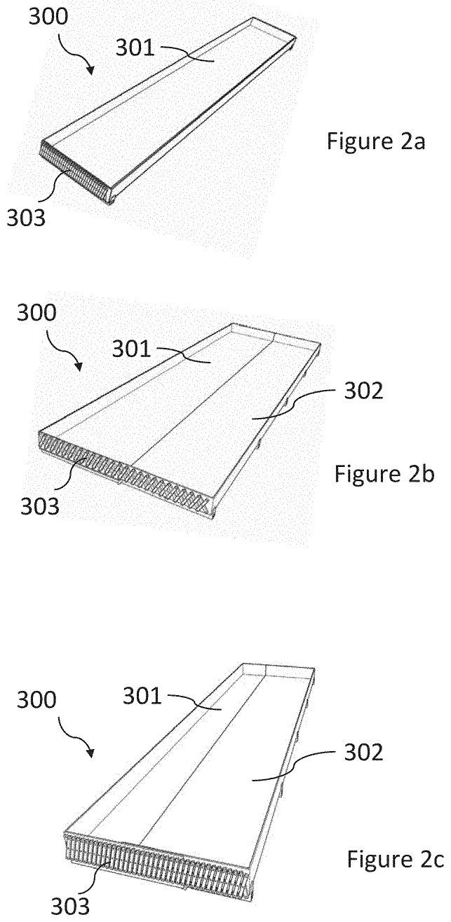

FIGS. 2-8 illustrate arrangements for adaptable growth trays.

The growth tray 300 illustrated in FIGS. 2a-c is extendable in one direction of the horizontal plane. The tray 300 shown is relatively long and narrow as shown in FIG. 2a. The narrow or short edge of the tray 300 is extendable to make the tray relatively wider compared with the compact narrow form. As illustrated in FIGS. 2a-c, the growth tray 300 has a telescopic arrangement, where a first portion 301 of the tray has a second portion 302 nested within the first portion 301. The second portion 302 is slidable relative to the first portion 301 to extend or increase the area of the tray. In the illustration, a scissor mechanism 303 arranged along the short edge of the tray is used to extend, and in reverse close or compress, the tray 300. The scissor mechanism 303 may also be used to lock the tray 300 in extended states between the minimum size or area, and the maximum size or area.

It will be appreciated that while the illustration shows first and second extending portions 301, 302, for simplicity, trays 300 having more than one overlappable nested second portions 302 are anticipated, to provide a larger increase in area and further widen the tray are anticipated.

In an alternative arrangement, rather than a telescoping mechanism, the tray may be made with a composite structure having a part made from an elastic material. For example, some 3D printing techniques allow for printing with two or more materials so that the material composition of the structure may be graduated. In some arrangements a compliant mechanism can be incorporated in the tray, with the functionality of a linkage mechanism.

Alternatively, the entire extendable surface of the tray can be made of an elastic material. An advantage of an elastic extendable surface is that the tray can easily be expanded in two dimensions simultaneously. Another advantage is that the elastic extendable surface is leak-proof and can easily retain water and soluble nutrients in the growth tray. A tray with a telescoping mechanism that extends in one dimension as shown in FIG. 2a-c can be made to hold water by sealing the seam between the nested first and second portions.

Another alternative would be for the extendable surface of the tray to be a concertina mechanism, in which the extendable surface is folded when the tray is in the compact configuration, and the extendable surface is unfolded when the tray is in the extended configuration.

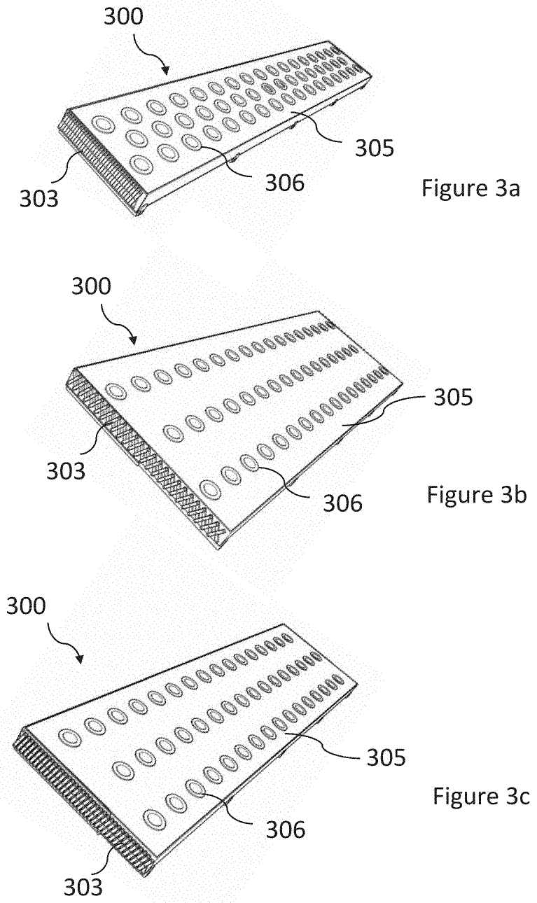

Typically, when growing without soil, using hydroponics or aeroponics, there needs to be a separating layer between the green zone i.e. the stems and leaves, and the root zone. Usually, no light should be allowed to reach the root zone, since, light, in the presence of water and nutrients could lead to algae growth. Accordingly, in use, an elastic cover sheet 305 may sit on top of or in the tray 300 as illustrated in FIGS. 3a-c.

As illustrated, the cover 305 comprises an array of substantially rigid eyelets 306. As the tray 300 is extended, the cover 305 may stretch to approximately match the size of the tray 300. As the cover 305 is stretched, space between rows of the array increases so that the eyelets 306 become more spaced apart.

One advantage of having substantially rigid eyelets 306 is that a substantially uniform sized openings in the cover 305, from compact to expanded configurations, are maintained.

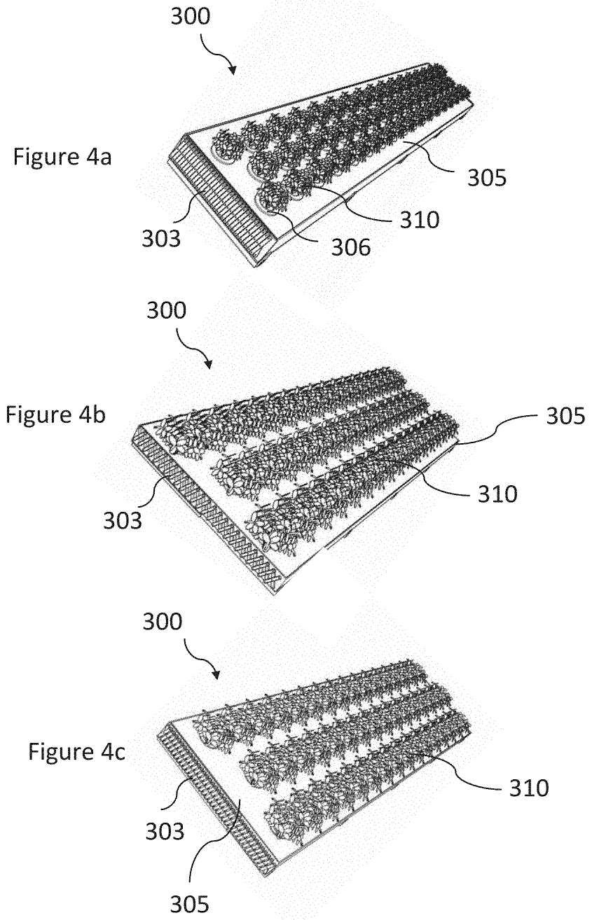

In use as illustrated in FIGS. 4a-c, the tray 300 and cover 305 begin in a collapsed or closed configuration and seedlings 310 are placed through the rigid eyelets 306. As the plants 310 grow, the tray 300 is extended and the plants 310 become more spaced apart. Advantageously, this arrangement gives the plants 310 space to develop and grow, remaining in situ, without the need to move the plants 310 from one growth tray to another, with different spacing as may be necessary conventionally. Moving growing plants requires labour and or machinery and can break the plant roots, particularly if the roots have become intertwined between plants. Broken roots may cause decay and infections in the growth medium which may be detrimental to healthy crop development and be detrimental to crop quality and yield.

Further, advantageously, when not in use, the trays 300 may be stored in a compact configuration and conveniently stacked.

It will be appreciated that the system illustrated by FIGS. 2-4 increases separation in one dimension, parallel with the one side of the tray 300.

Bi-stable Auxetic Metamaterials (BAMs) are a class of monolithic perforated periodic structures having a negative Poisson ratio. Under tension, a BAM can expand to reach a second state of equilibrium through a globally large shape transformation through flexibility of an elastomeric material, for example. Although in some arrangements a similar effect may be achieve through a mechanical linkage.

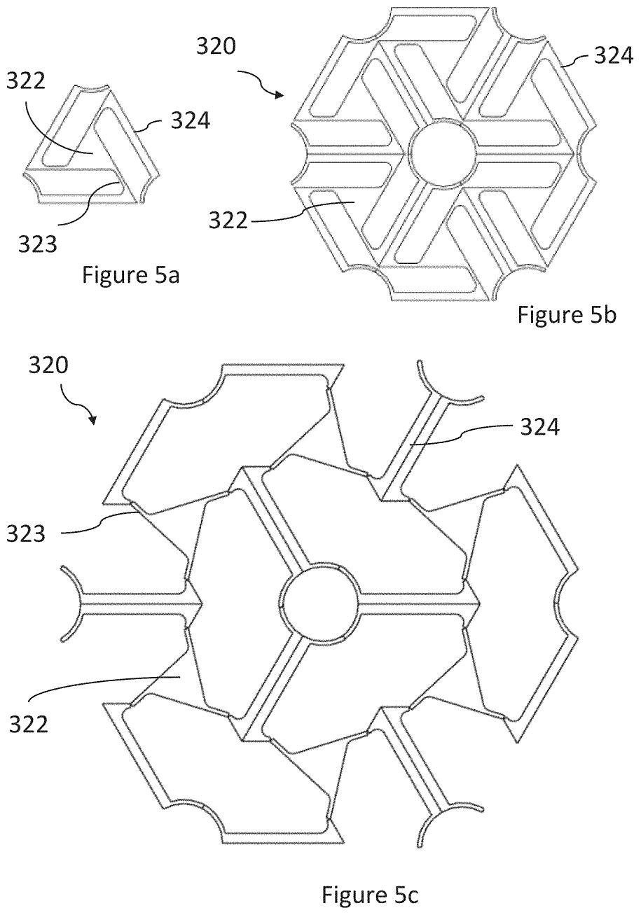

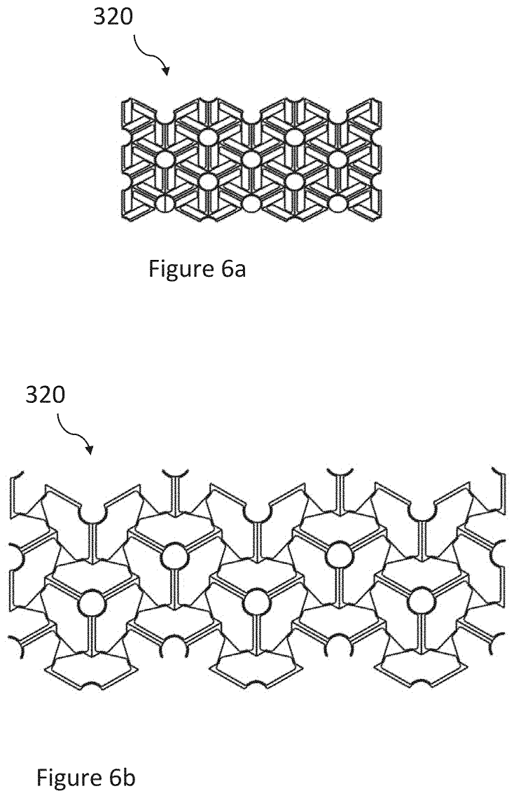

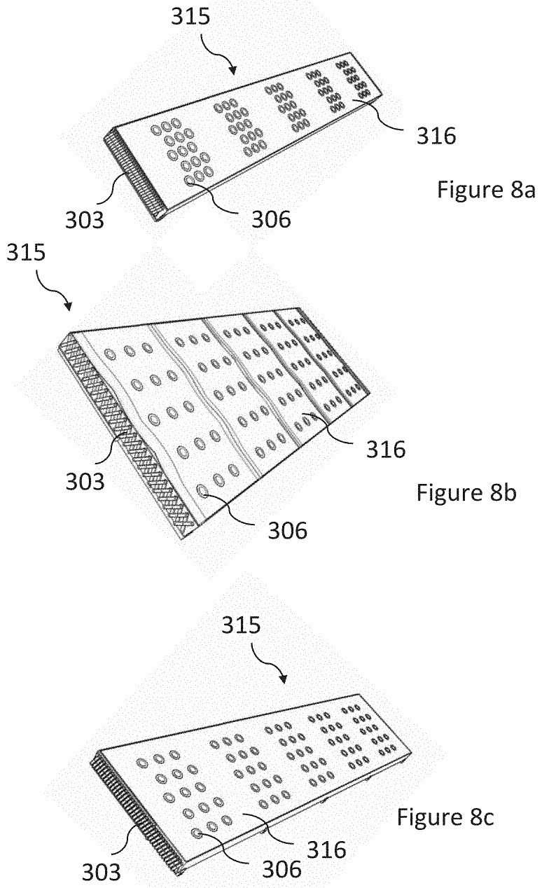

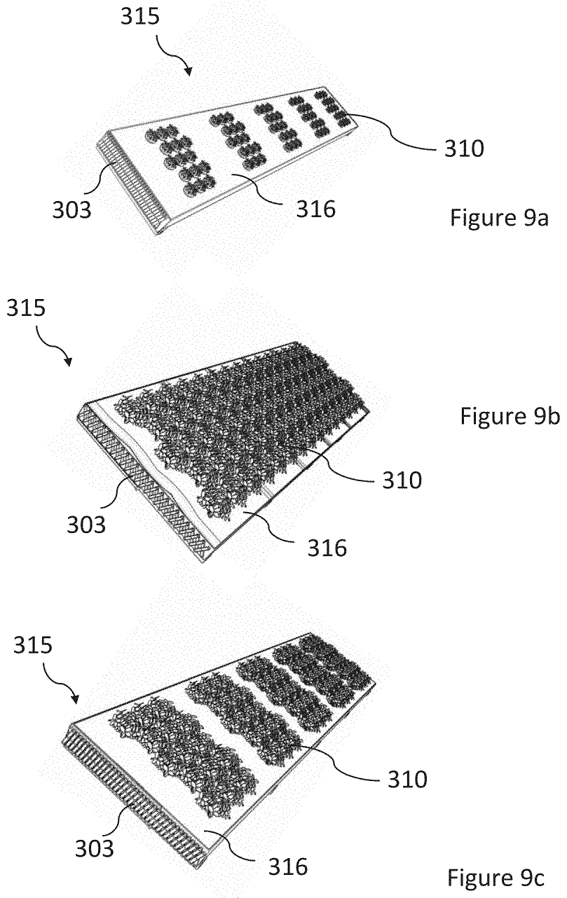

FIGS. 8 and 9 show an illustration of a BAM or “kirigami” architecture structure 320 with negative Poisson ratios may be implemented in a growth tray. FIG. 5a shows a single unit in a compressed state, FIG. 5b shows six units in a tessellating arrangement and FIG. 5c shows the tessellating arrangement in its extended state. FIG. 6 shows illustrates an array of mechanisms with a negative Poisson ratio of FIG. 5, FIG. 6a shows the array its compressed state, and FIG. 6b shows the arrangement in its extended state.

In the architecture a central triangular structure (or rotating unit) 322 comprises rotationally symmetrical ligatures 323 extending from each of the points of the triangular structure. The ligatures 323 from each unit connect with the ligatures of adjacent units via elements 324 to create a hexagonal repeat pattern in the compressed state. The ligatures 323 are compliant mechanisms, living hinges or joints which flex and allow the central triangles 322 to move between a compact configuration (FIGS. 5b, 6a) and an open configuration (FIGS. 5c, 6b). Thus, the arrangement has a negative Poisson ratio, i.e. expansion in 2 dimensions, when the architecture 320 is put under tension.

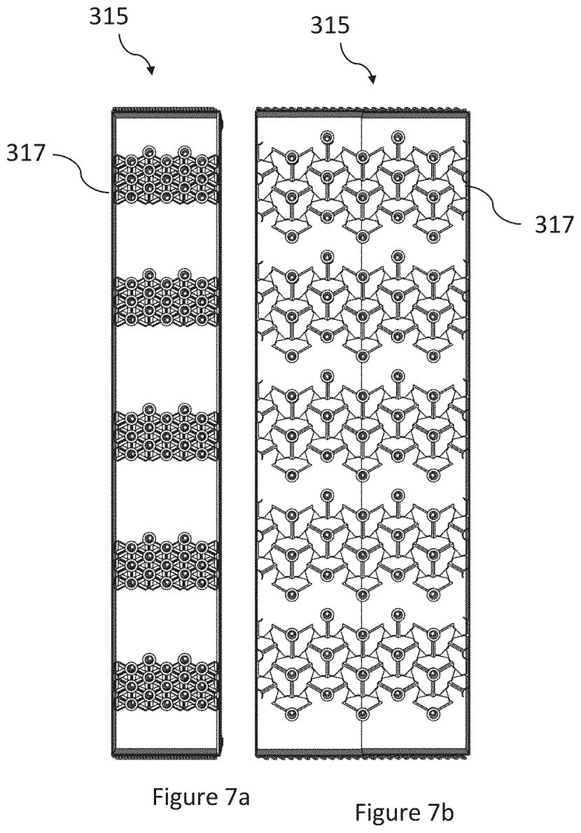

Following the “kirigami” architecture or an equivalent BAM approach for a surface structure, it is possible to make a growth tray 315 and cover 316 system for expansion in two dimensions, as illustrated in FIGS. 7a-b, 8a-c and 9a-c. Expansion units are located in clusters 317 along the compressed tray 315 (FIGS. 7a, 8a and 9a). The trays 315 are overlaid with a cover 316 (FIGS. 8a-c) having eyelets 306 arranged in groups or an array positioned substantially above the expansion units when in use and through which plants 310 may be grown (FIGS. 9a-c). The cover 316 may be similar to the cover 305 illustrated in FIGS. 3a-c used with a growth tray 300 that is expandable in one dimension. Typically the cover 305, 316 will be made from an elastic material.

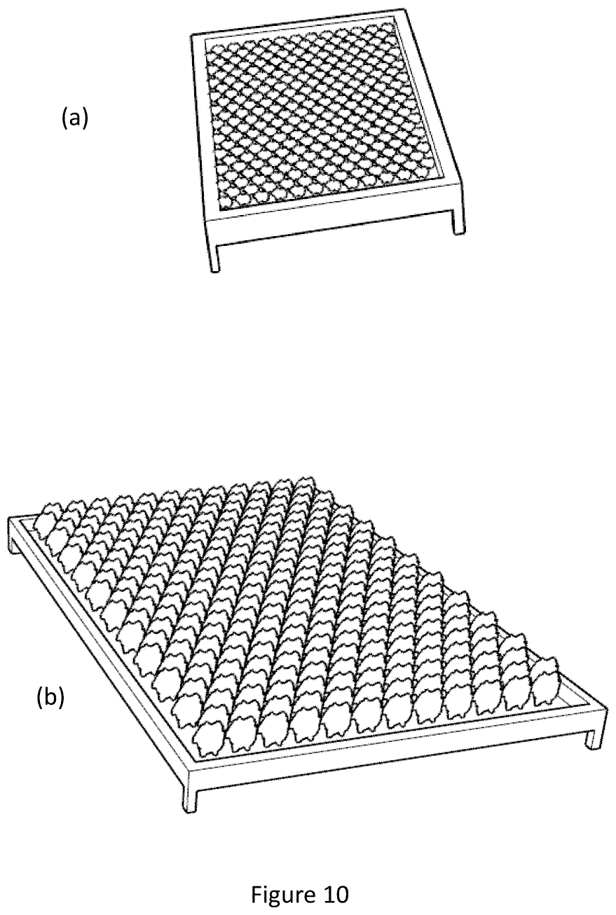

Another example of an extendable growth tray is illustrated in FIG. 10. The extendable growth tray is shown in (a) compressed, and (b) extended states.

The expanding and contracting of the adaptable growth tray can be achieved by any suitable mechanism. For example, as an alternative to the scissor mechanism described above, a screw mechanism or a rack and pinion mechanism can be used.

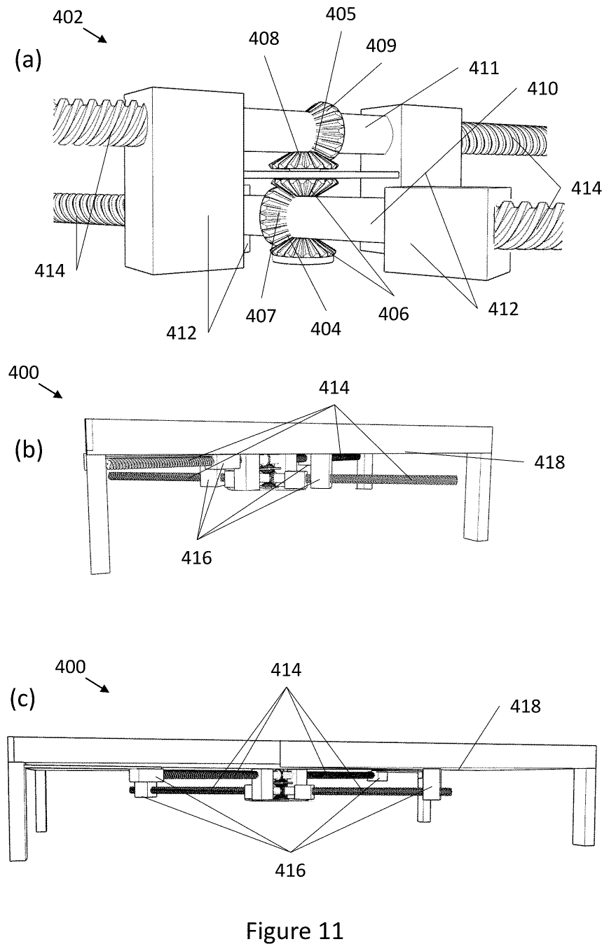

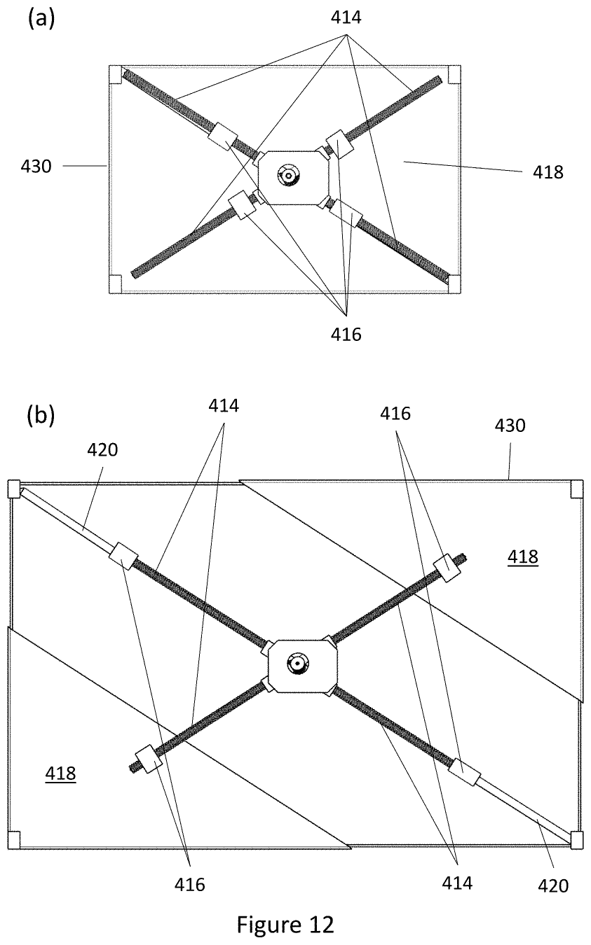

An exemplary embodiment of a screw mechanism 402 for expanding and contracting an adaptable growth tray 400 is illustrated in FIGS. 11 and 12. FIG. 11(a) shows the central part of the screw mechanism 402. The screw mechanism 402 comprises two sets of bevel gears stacked vertically, a lower set of bevel gears 404, and an upper set of bevel gears 405 stacked on top of the lower set of bevel gears 404. The lower set of bevel gears 404 comprises a pair of vertical-axis gears 406 meshing with a single horizontal-axis gear 407. The upper set of bevel gears 405 comprises a vertical axis gear 408 meshing with a horizontal-axis gear 409. The horizontal bevel gears 407, 409 are each mounted on a horizontal shaft 410, 411 respectively. The horizontal shafts 410, 411 are each supported by two bearings 412. The ends of the horizontal shafts 410, 411 comprise lead screws 414, each lead screw extending in a direction towards a respective corner of the adaptable growth tray 400. The screw threads on opposite ends of each horizontal shaft are arranged in opposite directions. As can be seen in FIG. 11(b) and (c), each of the four lead screws 414 extends towards a corner of the adaptable growth tray 400. Each lead screw 414 engages with a nut 416.

When the vertical-axis gears 406 of the lower set of bevel gears 404 are rotated, the vertical-axis bevel gears 406, 408 drive the horizontal-axis bevel gears 407, 409, causing the horizontal shafts 410, 411 to rotate. The lead screws 414 rotate with the horizontal shafts 410, 411 and each of the four lead screws 414 rotate at the same speed, causing the lead screws to synchronously move through the nuts 416, therefore causing the tray base 418 to expand or contract.

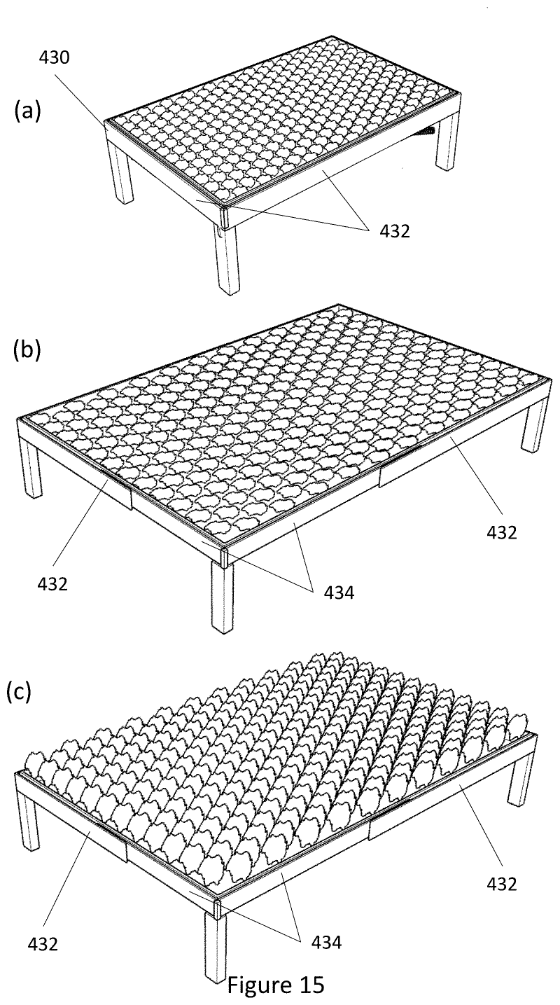

FIG. 12 shows a plane view of the extendable growth tray 400 with the screw mechanism 402 of FIG. 11, in (a) compressed, and (b) extended states. In the compressed or contracted state of FIG. 11(a), the four nuts 416 are located towards the inner ends of the lead screws, close to the bearings 412. As the screw mechanism is operated to expand the adaptable growth tray 400, the lead screws 414 move through so that the nuts 416 are located towards the outer ends of the lead screws, as illustrated in FIG. 12(b). In this embodiment, the tray base 418 is divided diagonally into two sections, each of which is attached to a nut 416 on opposing lead screws. As the screw mechanism 402 operates, the lead screws turn and drive the nuts 416 towards the outer ends of the lead screws 414, pushing the two sections of the tray base 418 apart. The other two nuts 416 are attached to rigid rods 420 attached to the other two corners of the extendable growth tray 400. The extendable growth tray is surrounded by an extendable frame 430, which will be described below in relation to FIG. 15.

Although a specific embodiment of a screw mechanism 402 has been described here, this embodiment is not intended to be limiting and the skilled person will appreciate that many alternative arrangements will be equally applicable. For example, different arrangements of gears and shafts are possible, and different numbers and directions of lead screws, and different means of attaching the nuts to the adaptable growth tray 400. The screw mechanism 402 can be actuated by any suitable means, for example by an inbuilt motor, or by a screwdriver or Allen key operated by a human or by an AGV.

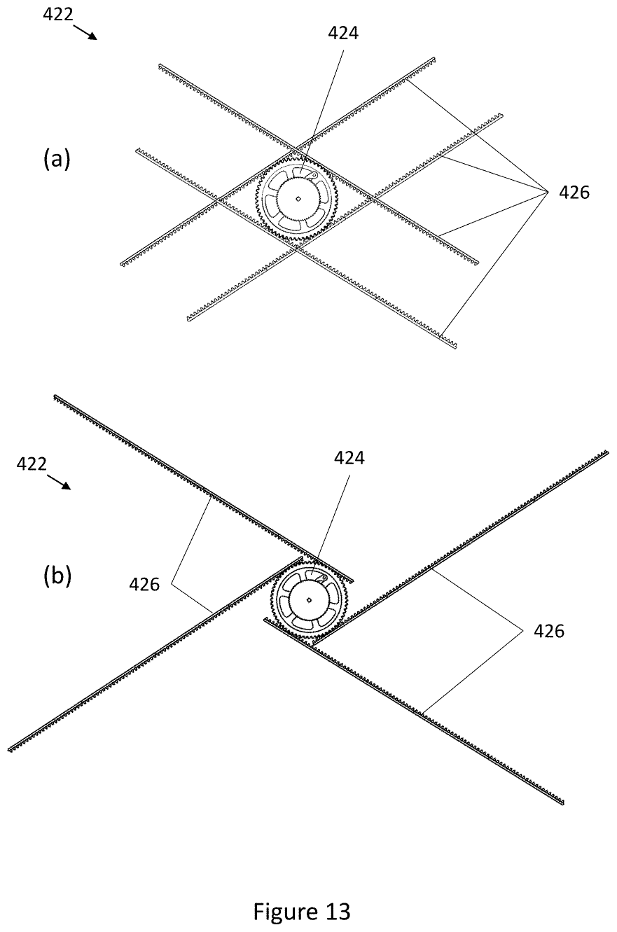

Another mechanism that can be used for expanding and contracting the adaptable growth tray is a rack and pinion mechanism. An exemplary embodiment of a rack and pinion mechanism 422 will now be described. FIG. 13 shows a plane view of the rack and pinion mechanism 422 in (a) compressed, and (b) extended states. The rack and pinion mechanism comprises a pinion or gear 424, meshing with four racks 426. When the mechanism is in compressed state as in FIG. 13(a), the pinion 424 engages with each of the racks 426 at around the centre of their length. As the pinion 424 rotates, each rack 426 moves until the point of engagement with the pinion is towards one end of the rack, until the racks are in expanded configuration as shown in FIG. 13(b).

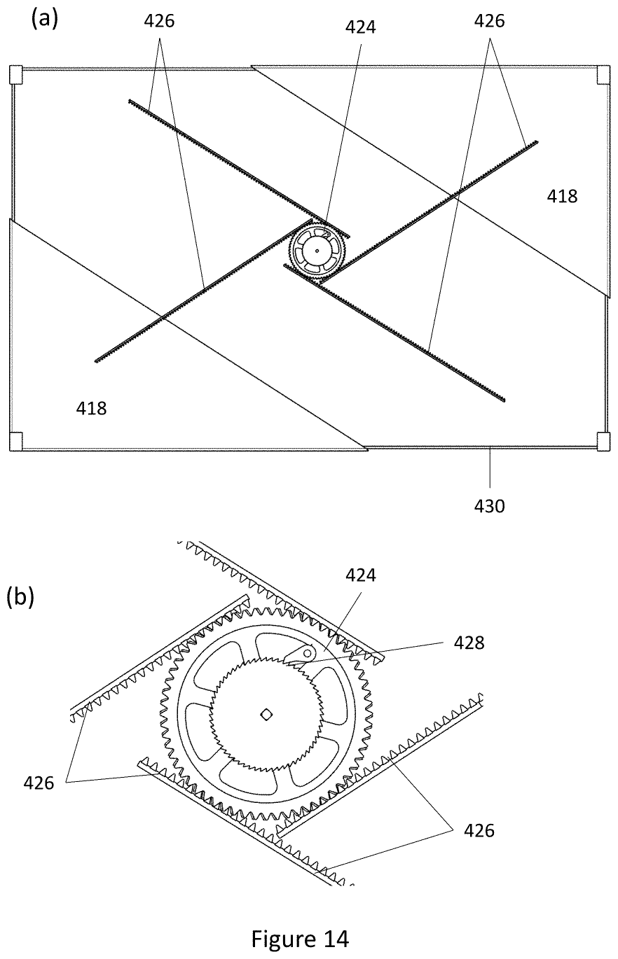

As the racks move, they push the tray outwards. In this embodiment of the rack and pinion mechanism 422, the tray base 418 is divided diagonally into two sections as shown in FIG. 14(a). The racks are attached to the sections of the tray base 418 by any suitable attachment means (not shown), such that the sections of the tray base 418 are pushed apart by the racks 426 as they move. As the tray base 418 expands, an adaptable frame 430 surrounding the tray expands at the same time.

The rack and pinion mechanism 422 has a ratchet mechanism 428, as illustrated in FIG. 14(b), to prevent the racks from moving in the reverse direction as the adaptable tray 400 exerts force on the racks.

Although a specific embodiment of a rack and pinion mechanism 422 has been described here, this embodiment is not intended to be limiting and the skilled person will appreciate that many alternative arrangements will be equally applicable. For example, different numbers or arrangements of racks are possible, and different means of attaching the racks to the adaptable growth tray 400. The rack and pinion mechanism 422 can be actuated by any suitable means, for example by an in built motor, or by a screwdriver or Allen key operated by a human or by an AGV.

FIG. 15 shows a perspective view of the extendable growth tray 400 with an extendable frame 430. The extendable frame is shown in (a) compressed, and (b) (c) extended states. The extendable frame 430 surrounds the extendable surface of the extendable growth tray 400. In the exemplary embodiment illustrated in FIG. 15, each side of the extendable frame 430 comprises a first portion 432 and a second portion 434. The first portion 432 and second portion 434 of each side of the tray are movable relative to each other. When the extendable frame 430 is in the contracted position as in FIG. 15(a), the second portions 434 of each side of the frame are nested within the first portions 432. As the extendable frame 430 is moved into the extended position as shown in FIG. 15(b), the first portions 432 slide relative to the second portions 434 such that each side of the extendable frame 430 increases in length. Although FIG. 15(b) shows two portions for each side of the extendable frame 430, if a greater extension is required more portions can be used in a similar telescoping arrangement. When the extendable frame 430 is in its extended state, the living organisms in the adaptable growth tray 400 have a greater available surface area for growing, so are able to grow to a larger size as in FIG. 15(c).

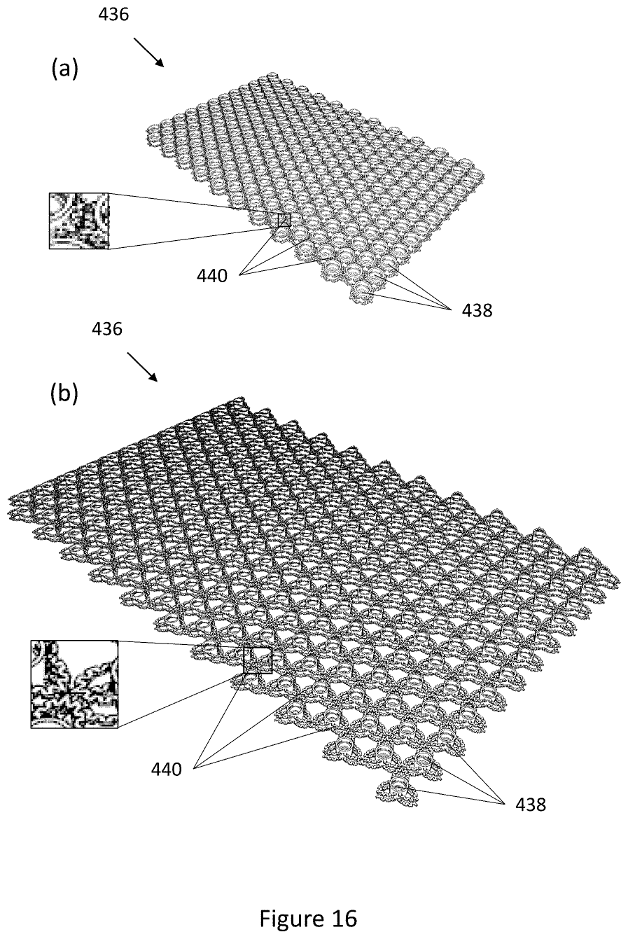

As described above in relation to FIG. 7, the extendable growth surface can have portions of extendable structure having negative Poisson ratio, with the remainder of the growth surface being non-extendable. This principle of parts of the surface being extendable and parts of the surface not being extendable is used in another exemplary embodiment of an extendable growth surface, as illustrated in FIG. 16. In this embodiment the extendable growth surface comprises an extendable assembly 436. The extendable assembly 436 comprises a plurality of pots 438 which are not themselves extendable, and a plurality of connecting members 440 interconnecting the plurality of pots. When the extendable assembly moves from the contracted position as shown in FIG. 16(a) to the expanded position as shown in FIG. 16(b), the connecting members 440 extend to increase the distance between the pots 438. The connecting members 440 may be elastic members, or rigid hinged members, or a compliant mechanism.

In the embodiment illustrated in FIG. 16, the connecting members 440 of the extendable assembly 436 are arranged in a double layer, vertically spaced apart. This arrangement has the advantage of supporting the pots 438 at both their tops and their bottoms, providing more stability and preventing the pots 438 from tipping over.

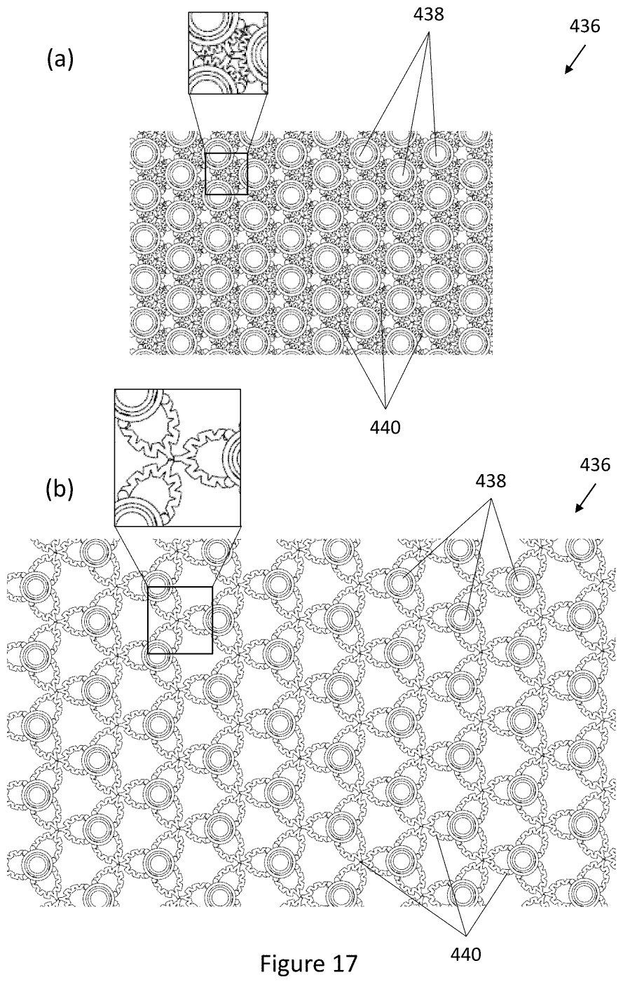

The connecting members can be seen more clearly in FIG. 17, which shows a plane view of the extendable assembly 436 of FIG. 16 in (a) compressed, and (b) extended states. The pots 438 are arranged in a hexagonal array, with the connecting members 440 between adjacent pots 438. The arrangement of connecting members 440 has a negative Poisson ratio, so that the extendable assembly expands in two dimensions when subject to tension, and contracts in two dimensions simultaneously when subject to compression.

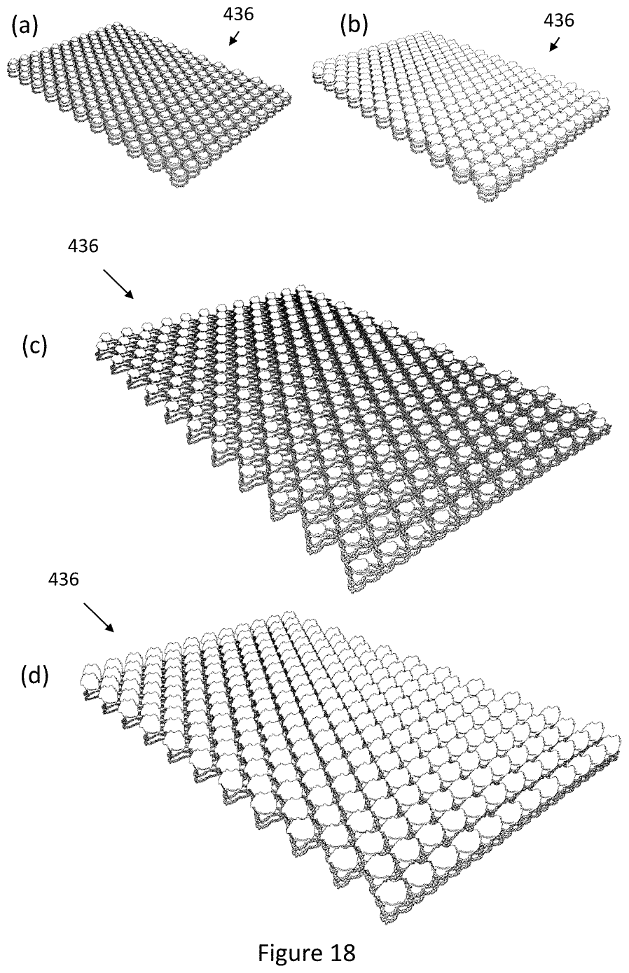

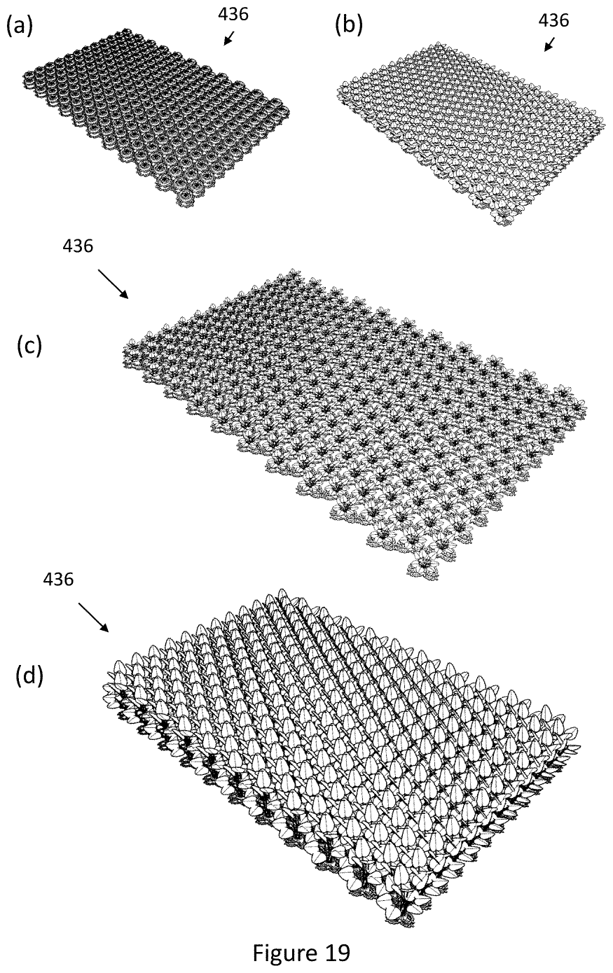

The operation of the extendable assembly 436 can be seen in FIGS. 18 and 19. These two figures illustrate how the extendable assembly 436 allows the growing organisms to occupy more space. FIGS. 18(a) and 19(a) illustrate the extendable assembly 436 in a compressed state with plants of small size. The living organisms grow until they occupy all of the space available in the compressed state and are of intermediate size, as shown in FIGS. 18(b) and 19(b). The extendable assembly 436 then expands to its maximum size as shown in FIGS. 18(c) and 19(c), with the living organisms still being of intermediate size. With the extra growing space available, the living organisms are able to grow to a large size, as shown in FIGS. 18(d) and 19(d).

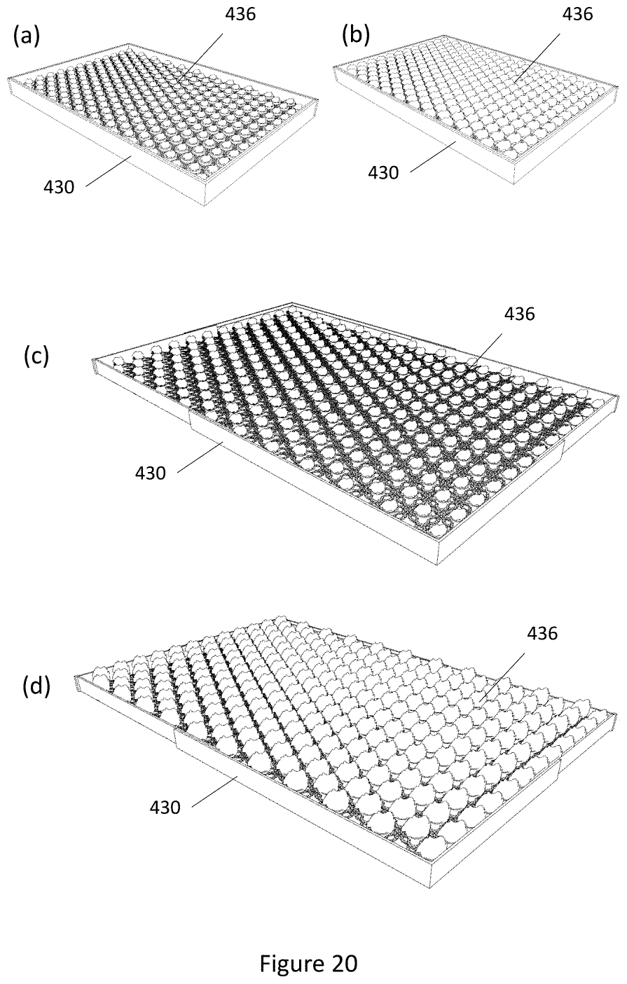

The extendable assembly 436 can be used in conjunction with the extendable frame 430 described above with reference to FIG. 15. FIG. 20 shows a perspective view of an extendable tray with the extendable assembly 436 and extendable frame 430: (a) in compressed state with small plants, (b) in compressed state with plants of intermediate size (c) in extended state with plants of intermediate size (d) in extended state with plants of large size. The extendable assembly 436 and the extendable frame 430 expand and contract together. The connecting members 440 at the edges of the extendable assembly 436 can be attached to the sides of the extendable frame 430 by any suitable attachment means.

As an alternative to the extendable frame 430, the extendable assembly 436 can be used in conjunction with an elastic frame. At least part of the elastic frame is made of elastic material, such that the elastic frame can expand and contract as the extendable assembly expands and contracts.

It will be appreciated that the extendable frame 430 or the elastic frame can also be used in conjunction with any other embodiments of the adaptable growth tray.

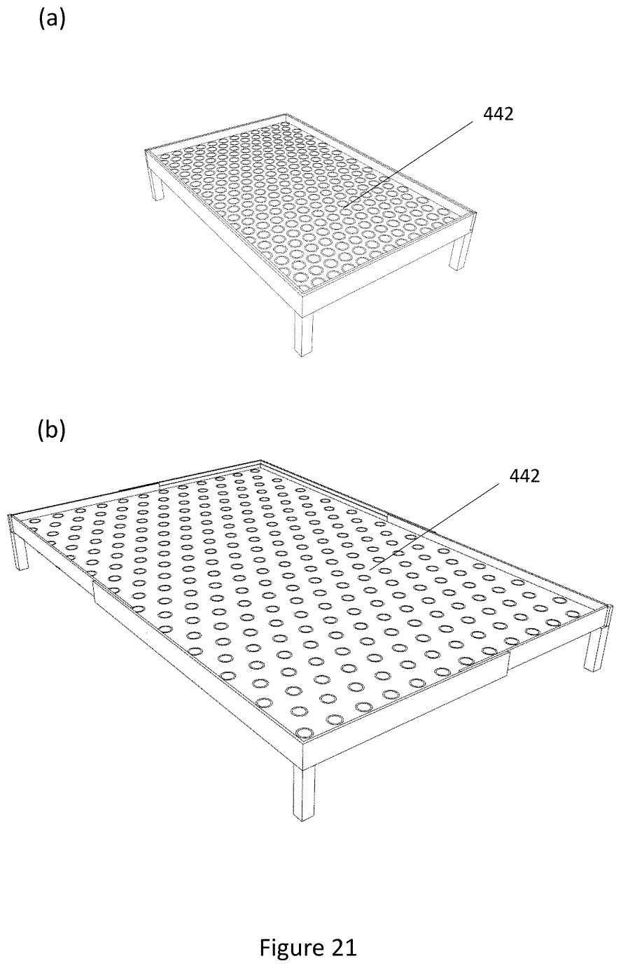

As with other embodiments of the extendable growth tray, the extendable assembly can 436 can be used with an extendable cover. An embodiment of an extendable cover 442 suitable for use with an extendable assembly is shown in FIG. 21 in (a) compressed, and (b) extended states. The extendable cover 442 is similar in construction an operation to the extendable covers 305 and 316 described above. The extendable cover 442 can be made of any suitable elastic material, and attached to the extendable frame 430 by any suitable attachment means. The extendable cover 442 comprises apertures arranged in a hexagonal grid pattern. In use the extendable cover is positioned above the extendable assembly 436, such that the tops of the pots 438 protrude through the apertures in the extendable cover 442.

Thus, a system 100 employing the growth rack 210 and trays 300, 315, 400 disclosed herein is able to provide sufficient space for the living organisms to grow in up to two directions/dimensions as the living organisms progress through their life-cycle ready for harvesting.

When the living organisms have grown to maturity the growth tray(s) 300, 315, 400 are transferred to a harvesting area 138, and harvesting the crop. The growth trays 300, 315, 400 may be transferred manually from the stack. Alternatively, a robotic or automated device such as a robotic load handling device suitable for operating with stacked storage systems may be employed to transfer the tray(s).

The hydroponic growing system described above with reference to the figures allows control of the growing environment and thus reduces the risk of microbiological contamination. In addition, the modular nature of the system allows for efficient use of space and ready scalability. Further, the expandable growing space for the plants of the crop reduce the need to thin or replant individual specimens. Further, the arrangement may maximise the use of resources such as lights to ensure that use of the light is maximised to be effectively used by the crop. The length, width and height of the rack units can be chosen to fit the available space. Accordingly crop yields and growing times are improved, contamination is minimised, shelf life is improved and the environmental impact is minimised.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

It will be appreciated that racks and growth trays can be designed for a particular application using various combinations of the specific devices and arrangements described above. Many variations and modifications not explicitly described above are also possible without departing from the scope of the invention as defined in the appended claims.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

Aspects of exemplary implementations are summarised in the following numbered clauses.

1. An adaptable growth tray for germinating, propagating and or growing living organisms, comprising at least one mechanism for moving the tray between a compact configuration and an expanded configuration, wherein the adaptable growth tray extends and contracts with the at least one mechanism moving between compact configuration and expanded configuration respectively.

2. An adaptable growth tray according to clause 1, further comprising an extendable surface for positioning living organisms, wherein the extendable surface extends and contracts with the at least one mechanism moving between compact configuration and expanded configuration respectively.

3. An adaptable growth tray according to clause 1, further comprising an extendable assembly comprising

a plurality of pots for positioning living organisms and

a plurality of connecting members interconnecting the plurality of pots,

wherein when the growth tray is in the expanded configuration the connecting members are extended to increase the distance between the plurality of pots.

1. A storing, germinating, propagating and or growing system for living organisms, the system comprising:
at least one growth medium for germinating, propagating and or growing living organisms;
at least one or more growth trays for receiving said at least one growth medium;
and at least one rack for receiving one or more growth trays,
wherein the one or more growth trays includes an adaptable growth tray according to claim 5.

2. The system according to claim 1, wherein the at least one rack comprises:
at least one service device to encourage propagation and or growth of a living organism(s) growing on one or more growth mats and arranged on at least one of the one or more growth trays.

3. The system according to claim 2, wherein the at least one rack comprises:
two or more platforms in stacked arrangement for receiving the one or more growth trays, and wherein the at least one service device comprises:
lights positioned above at least one of the two or more platforms.

4. The system according to claim 3, wherein the lights are located on an underside of at least one of the two or more platforms 21, to provide lighting to an adjacent-below platform in the stack.

5. An adaptable growth tray for germinating, propagating and or growing living organisms, the adaptable growth tray comprising:
an extendable surface for positioning living organisms; and
at least one mechanism for moving the adaptable growth tray between a compact configuration and an expanded configuration, wherein the extendable surface for positioning living organisms is configured to extend and contract with the at least one mechanism when moved between compact configuration and the expanded configuration.

6. An adaptable growth tray according to claim 5, wherein the extendable surface comprises:
a first portion and
one or more second portions, wherein the one or more second portions are configured to nest within the first portion and are movable relative to the first portion and relative to each other, and wherein when the adaptable growth tray is in the compact configuration the first and second portions are nested, and when the growth tray is in the expanded configuration the second portions are configured to expand to increase the extendable surface for positioning living organisms.

7. An adaptable growth tray according to claim 6, wherein the extendable surface comprises:
an extendable assembly which includes:
a plurality of pots for positioning living organisms; and
a plurality of connecting members interconnecting the plurality of pots, wherein when the adaptable growth tray is in the expanded configuration the plurality of connecting members are extended to increase a distance between the plurality of pots.

8. An adaptable growth tray according to claim 5, wherein the extendable surface is configured with a negative Poisson ration under tension and comprises:
a kirigami structure.

9. An adaptable growth tray according to claim 5, wherein the extendable surface comprises:
a bi-stable auxetic metamaterial (BAM).

10. An adaptable growth tray according to claim 5, wherein the extendable surface is configured to be extendable in two dimensions simultaneously.

11. An adaptable growth tray according to claim 5, wherein the at least one mechanism is a scissor mechanism 303 arranged along at least one edge of the extendable surface.

12. An adaptable growth tray according to claim 5, wherein the at least one mechanism is a screw mechanism.

13. An adaptable growth tray according to claim 5, wherein the at least one mechanism is a rack and pinion mechanism.

14. An adaptable growth tray according to claim 5, comprising:
A motor configured to motorize an expansion of the growth tray.

15. An adaptable growth tray according to claim 5, comprising at least one or more of:
an elastic cover having an array of holes arranged in rows, and/or a cover having an array of holes arranged in groups, wherein arranged array of holes is substantially complementary to the extendable surface, and/or wherein each of the holes in the array of holes is supported by a substantially rigid eyelet.

16. An adaptable growth tray according to claim 5, comprising:
an extendable frame surrounding the extendable surface, at least one side of the extendable frame including:
a first portion; and
one or more second portions, wherein the second portions are configured to nest within the first portion and are movable relative to the first portion and relative to each other, and wherein when the adaptable growth tray is in the compact configuration the first and second portions are nested, and when the growth tray is in the expanded configuration the second portions are expanded to increase the surface for positioning living organisms.

17. An adaptable growth tray according to claim 5, comprising:
an elastic frame surrounding the extendable surface.

18. A method of storing, germinating, propagating, and or growing at least one or more living organisms, the method comprising:
providing the at least one or more living organisms with a controlled environment to encourage germination, propagation and or growth of the living organisms; and
as at least one or more of the living organisms increases in size, expanding an available growing space for the at least one living organism to provide additional space in a plane containing the at least one living organism.

19. An adaptable growth tray according to claim 7, wherein the extendable surface is configured with a negative Poisson ration under tension and comprises:
a kirigami structure.

20. An adaptable growth tray according to claim 19, wherein the extendable surface is configured to be extendable in two dimensions simultaneously.
